(19) United States
(12) Patent Application Publication
(10) Pub. No.: US 2024/0402031 A1
(43) Pub. Date: Dec. 5, 2024

(54) DETECTION OF THE PRESENCE OF FUEL IN THE OIL OF AN AIRCRAFT ENGINE

(71) Applicant: SAFRAN AIRCRAFT ENGINES, Paris (FR)

(72) Inventors: Sébastien BOURGET, Moissy-Cramayel (FR); Eddy Stéphane Joël FONTANEL, Moissy-Cramayel (FR); Sébastien GAMEIRO, Moissy-Cramayel (FR); Gerard Philippe GAUTHIER, Moissy-Cramayel (FR)

(73) Assignee: SAFRAN AIRCRAFT ENGINES, Paris (FR)

(21) Appl. No.: 18/701,452

(22) PCT Filed: Oct. 18, 2022
(86) PCT No.: PCT/FR2022/051962

§ 371 Date: Apr. 15, 2024

(30) Foreign Application Priority Data
Oct. 29, 2021 (FR) FR2111562

(51) Int. Cl. G01M 3/02; G01F 23/62

(52) U.S. Cl. CPC G01M 3/02; G01F 23/62

(57) ABSTRACT

In order to detect possible leaks of fuel into oil used in an aircraft engine when their circuits are connected via a heat exchanger liable to deteriorate, a gauge measuring the liquid level in a tank in which the oil is stored, and incorporated into the oil circuit, is designed so that its float sinks to the bottom of the tank in the event of sufficient leakage, when the density of the mixture becomes lower.

The present application deals with the detection of the presence of fuel in the oil of an aircraft engine.

Heat exchanges between oil and fuel are used in some aircraft engines, where the oil is transported in a loop in a closed lubrication circuit and subjected to significant heating, in order to cool it down by the cooler fuel which passes through a supply circuit of the engine. The oil and fuel circuits both pass through a heat exchanger while remaining distinct. Damage to the heat exchanger can, however, put the circuits in communication, with a leak to the lower-pressure circuit and a mixture of the fluids, which is detrimental. If the fuel is at higher pressure and part of its flow therefore flows into the oil circuits, lubrication may be impaired. If the leak is too large, the oil-fuel mixture may overflow the enclosures of the lubrication circuit and migrate to hot zones in the engine where self-ignition of the oil-fuel mixture cannot be ruled out, a situation which has to be avoided.

The following documents may be referred to for more detailed knowledge of oil circuits in aircraft engines and especially dynamic bearing lubrication circuits, these circuits possibly being provided with oil storage tanks provided with gauges for measuring the liquid level in the tank.
FR 3 068 102 A1 and FR 3 074 848 A1 illustrate overflow discharge devices in oil tanks, in order to mitigate the consequences of fuel leaks into the oil;
EP 3 707 350 A1 illustrates an oil supply circuit one tank of which is provided with an oil level gauge with a magnetic float;
EP 3 304 010 A1, another gauge with a magnetic float in an oil tank;
WO 2020/201651 A1, a method for filling an oil tank, making optimum use of the indications of a gauge in the tank;
FR 3 074 848 A1, a complete example of a dynamic lubrication circuit.

A method currently applied to detect the presence of fuel in the oil consists in smell checks carried out by an operator between two flights of the aircraft. This method is obviously inaccurate, prone to human error, practicable only during engine maintenance and relatively time-consuming. The aim is therefore to be able to apply a more reliable, convenient and accurate method, which would also enable real-time diagnosis of leaks that appear during a flight and require immediate reaction.

In a general form, the invention relates to an aircraft engine having a fuel supply circuit and a lubrication circuit through which an oil flows, the lubrication circuit comprising a tank provided with at least one gauge for measuring liquid level in the tank, a heat exchanger where the supply circuit and the lubrication circuit are side by side, and the gauge comprising a float in the tank, characterised in that the float has a density greater than a mixture comprised, by volume, of X % of the fuel and (100−X) % of the oil; X is between 5 and 35.

As the fuel generally has a lower specific gravity than the oil, any leak of fuel into the oil results in a reduction in the specific gravity of the mixture formed, and a reduction in flotation and therefore in the emergence of the float. If the mixture becomes less dense than the float, the float will sink and the leak will be detected. And as the specific gravity of the float is easily adjustable, the fuel content of the mixture formed above which detection is made is determined by the designer of the device.

In practice, it is advantageous to recommend that X=20, or that the density of the float be between 80% and 95% of the density of the oil.

According to some advantageous constructions, the float is a magnetic float comprising a permanent magnet; it comprises a shell comprised of assembled halves and containing a hollow volume, wherein the permanent magnet is attached to one of the halves at a position off-centred from a geometric centre of the shell; the hollow volume comprises a ballast placed on a bottom surface of the hollow volume; the ballast is comprised of a plurality of ballast units deposited into the hollow volume.

Another aspect of the invention is a method for detecting a fuel leak in a lubrication circuit of an aircraft engine, the lubrication circuit comprising an oil tank containing at least one liquid level measurement gauge, the gauge comprising a float, and a heat exchanger with a circuit for transporting a fuel of the engine, the float having a density lower than a density of an oil circulating in the lubrication circuit and greater than a density of the fuel, characterised in that the fuel leak is detected for a state of the float going down to a lower level of the gauge, simultaneous with an operating pressure considered to be normal in the tank.

The invention will now be described in detail by means of the following figures, which illustrate particular embodiments thereof given purely by way of illustration

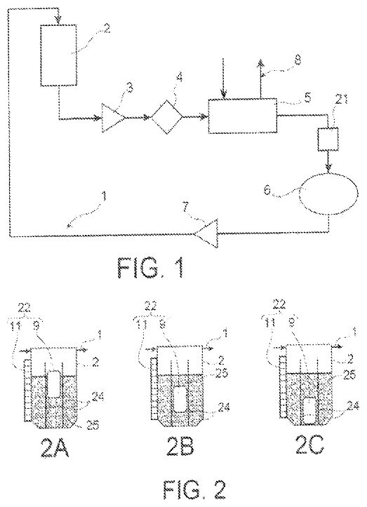

FIG. 1 schematically represents an oil lubrication circuit;

FIG. 2, the principle on which the invention is based;

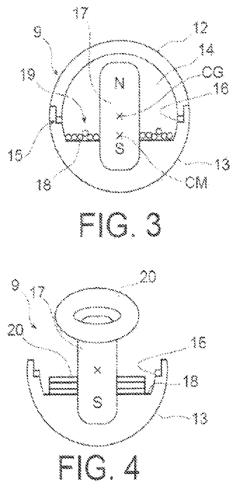

FIG. 3, one embodiment of a magnetic float;

FIG. 4, one alternative embodiment of the float; and

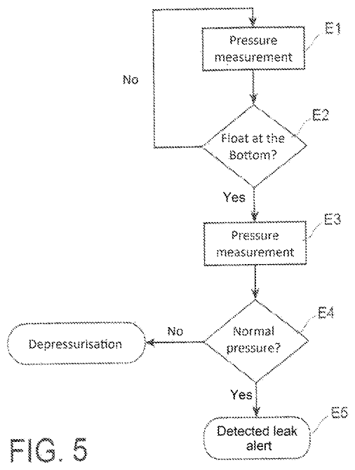

FIG. 5, the method used.

An oil lubrication circuit 1 for an aircraft engine (this engine being otherwise known, and therefore not represented in its entirety) is first depicted in FIG. 1. It comprises a closed-loop duct 1, passing successively (according to the direction of oil circulation) through an oil storage tank 2, a first pump 3, a filter 4, a heat exchanger 5, an enclosure 6 to be lubricated of the engine, and a second pump 7. In practice, the enclosure 6 may contain one or more bearings to be lubricated. It may be closed, communicate with the outside only via seals with a very low leak flow, or communicate with other enclosures under excess pressure and with a dry atmosphere, so that the entire circuit can be considered closed: the amount of oil it contains should remain constant or nearly constant.

The heat exchanger 5 is intended to cool the oil, and a pressurised fuel supply circuit 8, intended to supply the engine and still cold, passes through it. If a wall of the heat exchanger 5 which separates the two circuits (the exchanger may comprise a group of parallel tubes through each of which a flow of fuel flows, or consist of a plate heat exchanger) is perforated, fuel may leak into the lubrication circuit 1 and accumulate there more or less rapidly, thus increasing the volume of fluid in the oil circuit. The fluid, made up of a mixture of oil and fuel, then risks leaking out of the enclosure and reach very hot parts of the engine, with a risk of self-ignition of the mixture, which is absolutely to be avoided.

FIG. 2, comprising three parts 2A, 2B and 2C illustrating successive phases of the state of the tank 2 in the event of a leak, shows that the tank 2 contains a float 9, whose density or specific gravity is therefore lower than that of the oil. The oil level is correlated to the height of the float 9 in the tank 2. A level measurement gauge 22 comprises, in addition to the float 9, a scale of graduations 11 in measuring relationship with the float 9 and which therefore makes it possible to measure its height. In the frequent case, mainly considered here, where the float 9 is a magnetic float, the scale of graduations 11 can take the form of a succession of electrical circuits selectively subjected to the magnetic induction of the float 9, as detailed in a document (EP 3 707 350 A1) above mentioned. The level measurement gauge 22 is typically used to monitor variations in the height of the liquid phase present in the tank 2 and to alert in the event of the tank draining or, on the contrary, overflowing.

In preferred embodiments of the invention, the float 9 will have a small emerged volume, such as that represented in part 2A, and which will commonly be between 5% and 20% of the volume of the float.

If fuel from the supply circuit 8 now leaks into the lubrication circuit 1, the composition of the liquid phase present in the tank 2 changes and its density decreases, since fuel for aircraft engines is less dense than the oils commonly used. The emergence of the float 9 decreases (according to part 2B of FIG. 2); and, if the specific gravity of the float 9 has been judiciously chosen, it becomes greater than that of the mixture as soon as the fuel reaches a determined content in the oil, which implies that the float sinks to the bottom of the tank 2 (according to part 2C of FIG. 2). It is considered that during operation, the flow rate of oil pumps such as pumps 3 and 7 is high, and that the oil in the tank 2 is renewed rapidly by closed-circuit circulation. Typically, the average residence time of the oil in an oil tank of an aircraft engine is less than 20 seconds, and generally less than 10 seconds. The fuel arriving in the tank 2 and mixed with the oil therefore has no time to settle significantly before being sucked towards the outlet of the tank 2. It is therefore considered that the specific gravity of the oil-fuel mixture remains relatively homogeneous in the entire tank 2, and that the float 9 sinks rapidly to the bottom of the tank 2 (or the vertical travel provided to the float 9) when the fuel content has reached the emergence limit. In addition, the float remains at this lower position with no change hereinafter, whatever the variations in the height of the liquid in the tank 2. Instead of providing the position of the height of the liquid, the float 9 therefore indicates a lower position which is then used to diagnose the fuel leak. The density of the float 9 is chosen to give leak detection when a content of X % of fuel in the oil is reached. A detection threshold of, for example, X=20% can be contemplated; this corresponds to densities of the float 9 of between 80% and 95% of that of the oil for common oils and fuels.

Turning to FIG. 3. The float 9 may be spherical in shape and comprise a shell comprised of two halves 12 and 13 completely enclosing a hollow volume 14 and joined at an interface 15 which may be screwed and provided with a seal 16. A permanent magnet 17 is contained within the hollow volume 14 by being partially embedded in one of the halves 13. Although the external shape of the float 9 may be spherical as here, the float is designed not to tilt significantly when floating, that is, to maintain substantially a same orientation of the permanent magnet 17, typically a vertical orientation of the magnet axis. This is achieved if its centre of mass CM is distinct from the geometric centre CG, which also corresponds to the centre of flotation, because the float 9, even when free, keeps the centre of mass CM below the geometric centre CG. Their distance can be obtained either by off-centring the position of the permanent magnet 17 or, as represented here, by constructing one of the halves 13 much more massive than the other. Here, the half 13 includes a planar internal surface 18 facing into the hollow volume 14. Ballast balls 19 can be placed on this internal face 18, and even left free to move, since the float 9 is supposed to remain at an invariable orientation. The balls 19 determine the density of the float 9. The manufacturer of the device is free to easily adjust the specific gravity of the float 9, and therefore the fuel leak detection threshold, that is, the fuel content in the oil which suppresses the emergence of the float 9, by choosing the number of the balls 19 or more generally the ballast units. A contemplatable threshold for triggering the detections is a proportion by volume of 20% of fuel in the mixture. The density of the float 9 can also be adjusted to take account of different varieties of oil or different temperatures in the lubrication circuit, as will be explained in more detail below. If necessary, it will be possible to manufacture several similar floats 9, ballast them to different values, and choose the best suited to a particular tank or circuit.

The same result could be obtained with other ballasting means, such as washers 20, represented in FIG. 4 and fitted around the permanent magnet 17, which is here in the form of a vertically oriented rod with its apex exposed in the empty volume 14.

Numerous other construction alternatives are possible. The solid ballast could be replaced by a liquid ballast deposited in droplets, each of which constituting a ballast unit. Many other types of floats, for example in terms of the shape of their shell, can also be provided. The float 9 can thus be cylindrical, as illustrated in FIG. 2.

However, a disturbing phenomenon needs to be discussed. Unlike oil and fuel, whose specific gravities change considerably as a function of temperature, that of conventional floats varies little. The emergence limit of floats would therefore be reached at fuel concentrations that vary according to the temperature of the mixture. This drawback can be reduced by using a material with a high coefficient of thermal expansion for the external shell of the float 9 (for example, PTFE). Indeed, PTFE has a coefficient of thermal expansion close to that of common oils. The variations in specific gravity of the float 9 and the oil, as a function of temperature, become close to each other and detection is more uniform. Constructing at least the external shell of the float 9 in PTFE has the added advantage of allowing it to slide easily in common vertical guide rules 24 to guide it by delimiting a guide column 25 in the tank 2.

An oil pressure probe 21, represented in FIG. 1 and installed on the lubrication circuit 1, for example at the inlet of the enclosure 6, is used to avoid some incorrect diagnoses. If indeed the circuit loses its oil and there is no fuel leak into the oil, the float 9 also goes down to the bottom of the tank 2, but at the same time the value of the oil pressure decreases sharply and falls below an alert threshold well below the nominal pressure of the circuit. The detection of the float in the low “tank empty” position combined with the detection of abnormally low oil pressure will therefore not trigger a fuel-in-oil leak alert, but a loss-of-oil alert. Incorrect detection of fuel leak into the oil can therefore be avoided by checking that the oil pressure in the lubrication circuit, preferably measured at the inlet of the lubrication chambers, remains at the desired operating pressure.

The method in accordance with the invention is described schematically in FIG. 5. The height of the float 9 of the level measurement gauge 22 is measured continuously in step E1. A determination is then made in step E2. If the float 9 is above the bottom of the tank 2, the algorithm returns to the start of the method. If the level measured by the level measurement gauge 22 is too high or too low without being at the bottom of the tank 2, an overfill or underfill is detected, but this is outside the scope of the present invention. If the float 9 is at the bottom of the tank 2, the oil pressure in the lubrication circuit is measured in step E3. If the oil pressure is low, depressurisation due to draining of the oil circuit is diagnosed in step E4. If the pressure remains normal, a fuel leak in the oil is diagnosed, and an alert can be given in step E5.

1. An aircraft engine having a fuel supply circuit and a lubrication circuit through which an oil flows, the lubrication circuit comprising a tank provided with at least one gauge for measuring liquid level in the tank, a heat exchanger where the supply circuit and the lubrication circuit are side by side, and the gauge comprising a float in the tank, wherein the float has a density greater than that of a mixture comprised, by volume, of X % of the fuel and (100−X) % of the oil, where X is between 5 and 35.

2. The engine according to claim 1, wherein X=20.

3. The engine according to claim 1, wherein the density of the float is between 80% and 95% of the density of the oil.

4. The engine according to claim 1, wherein the float is a magnetic float comprising a permanent magnet.

5. The engine according to claim 4, wherein the float comprises a shell comprised of assembled halves and containing a hollow volume, wherein the permanent magnet is attached to one of the halves, the float having a centre of masses off-centred from a geometric centre of the shell.

6. The engine according to claim 5, wherein the hollow volume comprises a ballast placed on a bottom surface of the hollow volume.

7. The engine according to claim 6, wherein the ballast is comprised of a plurality of ballast units deposited into the hollow volume.

8. The engine according to claim 3, wherein the float has a PTFE outer shell.

9. A method for detecting a fuel leak in a lubrication circuit of an aircraft engine, the lubrication circuit comprising an oil tank provided with at least one liquid level measurement gauge, the gauge comprising a float in the tank, the lubrication circuit comprising a heat exchanger with a circuit for transporting a fuel of the engine, the float having a density lower than a density of an oil circulating in the lubrication circuit and greater than a density of the fuel, wherein the fuel leak is detected for a state of the float going down to a lower level of the gauge, simultaneous with an operating pressure considered to be normal in the tank.
